(19) United States
(12) Patent Application Publication
(10) Pub. No.: US 2005/0244762 A1
(43) Pub. Date: Nov. 3, 2005

(54) Method for reducing sensitizing dye stain

(75) Inventors: Leif P. Olson, Rochester, NY (US); Kurt M. Schroeder, Spencerport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/838,131

(22) Filed: May 3, 2004

(51) Int. Cl. G03C 1/005

(52) U.S. Cl. 430/434; 430/448

(57) ABSTRACT

The present invention relates to a method for reducing sensitizing dye stain comprising the steps of providing an exposed sensitized imaging element comprising a support having thereon at least one imaging layer comprising at least one sensitized emulsion and at least one dye dispersion comprising dye and a water soluble dye stain reducing surfactant and processing the exposed sensitized imaging element in a developing solution essentially free of dye washout agent.

### FIELD OF THE INVENTION

The present invention relates to a method for reducing sensitizing dye stain, especially in color paper. The present invention relates to coating and processing compositions for silver halide color photographic light-sensitive materials and image forming methods using the same, and, in particular, to such compositions and methods that can effectively suppress stain generation caused by spectral sensitizing dyes remaining in the photographic materials after processing.

### BACKGROUND OF THE INVENTION

It has been a traditional practice to perform several separate steps after color development, for example removal of metallic silver (bleaching), removal of unreacted silver halide (fixing), a washing process, and perhaps other processes to obtain an image by processing an imagewise-exposed silver halide color photographic light-sensitive material.

Typically, such traditional processes have been performed by centralized photofinishing facilities. Such facilities receive light-sensitive materials, for example, exposed but unprocessed film, delivered from numerous locations, and return processed light-sensitive materials, for example, exposed and processed film and color prints, back to those locations, generally within 24 to 48 hours from the time that the unprocessed materials were delivered.

More recently, however, there has been a trend toward rapid processing, with several hours from reception to finish, due to the availability of in-house processing equipment known as “mini-labs”. This has led to demands for very rapid processing, perhaps within one hour, to improve service quality for users. This has been associated with newer processing methods, for example the rapid process for color paper known as Process RA-4™ (Eastman Kodak Company). In RA-4 processing, development is carried out at 35° C. for 3 minutes, with the entire process comprising 45 seconds of color development, 45 seconds of bleach-fixation and 90 seconds of stabilization by washing.

With short processing times, as in process RA-4 for color paper, residual dye stain may occur due to poor elution of the spectral sensitizing dyes contained in the light-sensitive material into the processing solutions. In the case of color prints, a noticeable amount of retained spectral sensitizing dye causes the light-colored or white areas of the print to assume color, thus deteriorating the print appearance.

One method to reduce the levels of dye stain in color prints is to promote the elution of the spectral sensitizing dye into the processing solutions by means of a fluorescent optical brightening agent, as described in Research Disclosure (RD) 20733. Another method for dye stain reduction, disclosed in Ueda et al., EP 0 465 228 A2, is by means of a stabilizing solution with a surface tension of 15 to 60 dyne/cm. This surface tension is achieved by addition of a surface-active agent to the stabilizing solution. It is also well known in the art to include surfactants in imaging elements. For example, U.S. Pat. Nos. 5,591,568, 6,555,304, 6,558,886 discloses the use of surfactants in imaging layers, and U.S. Pat. No. 5,135,844 discloses the use of Pluronic surfactant in the overcoat layer of an imaging element, both to enhance the activity of coupler materials.

However, even with use of the abovementioned dye stain reduction methods, residual dye stain in color prints may still be noticeable, due to the short time available for stain removal during rapid processing. Furthermore, use of optical brightening agents to promote elution of spectral sensitizing dye into processing solutions is associated with problems such as (1) the cost of the optical brightener; (2) insolubility, especially at low temperatures, of some optical brighteners in concentrated solutions for use in replenishment of processing solutions; and (3) deterioration of perceived print quality, due to alterations in print color balance introduced by the fluorescence of the optical brightener retained in the color paper after processing.

### PROBLEM TO BE SOLVED

There remains a need for a method to produce color prints with reduced residual dye stain, while at the same time eliminating the problems introduced by the presence of an optical brightening agent in the processing solutions.

### SUMMARY OF THE INVENTION

The present invention relates to a method for reducing sensitizing dye stain comprising the steps of providing an exposed sensitized imaging element comprising a support having thereon at least one imaging layer comprising at least one sensitized emulsion and at least one dye dispersion comprising dye and a dye stain reducing water soluble surfactant comprising a 6 to 22 carbon atom hydrophobic tail with one or more attached hydrophobic chains comprising at least 8 oxyethylene and/or glycidyl units; and processing said exposed sensitized imaging element in a developing solution essentially free of dye washout agent. The present invention also includes a method for reducing sensitizing dye stain comprising the steps of providing an exposed sensitized imaging element comprising a support having thereon at least one imaging layer comprising at least one sensitized emulsion and at least one dye dispersion comprising dye and a water soluble polyoxyalkylene polymer dye stain reducing surfactant, wherein said water soluble polyoxyalkylene polymer dye stain reducing surfactant comprises polyoxypropylene blocks (block A) and polyoxyethylene blocks (block B) connected together by an organic moiety whereby there is a minimum of about 40% polyethyleneoxide blocks in the molecule as represented by a structure selected from the group consisting of A-B-A, B-A-B, A-B, (A-B)n==G==(B-A) or (B-A)n==G==(A-B), whereby G is a connective organic moiety and n is between 1 and 3; and processing said exposed sensitized imaging element in a developing solution essentially free of dye washout agent and a method for reducing sensitizing dye stain comprising the steps of providing an exposed sensitized imaging element comprising a support having thereon at least one imaging layer comprising at least one sensitized emulsion and at least one dye dispersion comprising dye and a water soluble polyalkylene oxide-modified polydimethylsiloxane dye stain reducing surfactant of the general formula given by C: 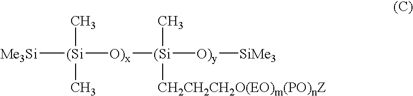
wherein, EO represents ethylene oxide, PO represents propylene oxide, and Z can be either H or a lower alkyl radical; and processing said exposed sensitized imaging element in a developing solution essentially free of dye washout agent. In addition, the present invention relates to a method for reducing sensitizing dye stain comprising the steps of providing an exposed sensitized imaging element comprising a support having thereon at least one imaging layer comprising at least one sensitized emulsion and at least one dye dispersion comprising dye and a water soluble alkylpolyglycoside dye stain reducing surfactant of general formula D: 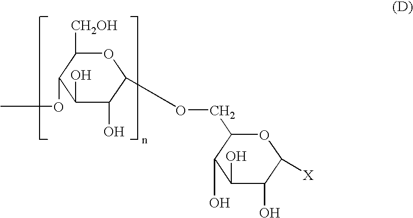
wherein, n is 0 to 3 carbohydrate units, and X represents a group of type R₁, OR₁, SR₁, or N(R₁)(R₂), wherein R₁ represents functional groups selected from the goup consisting of carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide; and R₂ is selected from the group consisting of a hydrogen atom, carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide; and processing said exposed sensitized imaging element in a developing solution essentially free of dye washout agent.

### ADVANTAGEOUS EFFECT OF THE INVENTION

The invention has numerous advantages over practices in the prior art, not all of which may be incorporated into a single embodiment. Color prints made using the method of the invention demonstrate reduced residual dye stain. Furthermore, the elimination of optical brightening agents from the processing solutions results in lowered manufacturing costs, elimination of optical brightener insolubility problems, and reduction of perceived print quality deterioration, due to alterations in print color balance introduced by the fluorescence of the optical brightener retained in the color paper after processing.

### DETAILED DESCRIPTION OF THE INVENTION

The present invention relates to the development of a silver halide color photographic light-sensitive material, comprising a support and a silver halide emulsion having an average silver chloride content of not less than 80 mol % coated thereon, by means of a modified RA-4 processing method, including color development and subsequent bleaching, fixation, and stabilization, wherein a surface-active agent is incorporated by coating into the light-sensitive material, and the processing solutions are essentially free of fluorescent brightening agents. For purposes of the present invention, essentially free means that the processing solution contains no intentionally added optical brightening agent, but considers that some insignificant amount may be present as a residual contaminant. This yields a color print that has optimum whiteness in the low-density regions of the image, while at the same time avoiding problems posed by the necessity of using an optical brightener to assist in elution of spectral sensitizing dye.

The present invention aims at promoting the elution of weakly hydrophilic sensitizing dyes by adding a water-soluble surfactant directly to the light-sensitive material, directly at the site in which staining is likely to occur.

While there is precedent for this method of dye stain reduction, the novel and unprecedented aspect of the invention is that when the surfactant is coated in the light-sensitive material, the elution of the sensitizing dyes is more efficient when the optical brightener is substantially absent from the processing solutions. It is also novel and unexpected that this effect only holds true when the surfactant is introduced into the light-sensitive material at the time of manufacture, and not when introduced as a component of the processing solutions.

The water soluble surface active agents coated in the light sensitive element of the present invention may be chosen from the following classes of surfactants:

Type A: Water soluble surfactant comprising a 6 to 22 carbon atom hydrophobic tail with one or more attached hydrophobic chains comprising at least 8 oxyethylene and/or glycidyl units that may or may not be terminated by an anionic charge such as a sulfate or sulfonate group.

TABLE A
Examples of Type A surfactants useful in the present invention.

| | | | Molecular |
|---|---|---|---|
| ID | Manufacturer | Structure | Weight |
| A-1 | Triton- X165 Union Carbide | 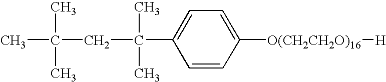 | 910 |
| A-2 | Tergitol 15S- | (C₁₁to₁₅—H₂₃to₃₁)—O—(CH₂CH₂O)₁₅—H | 875 |
| | Union | | average |
| | Carbide | | |
| A-3 | Brij-97 | C₁₈H₃₇ —O—(CH₂—CH₂—O)₁₀ —H | 710 |
| | Uniquema | | |
| A-4 | Olin-10G (Dixie) | 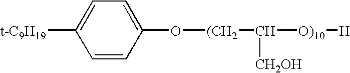 | 961 |
| A-5 | Polystep B-23 | n-C₁₂H₂₅—O—(CH₂—CH₂—O)₂₃—SO₃⁻Na⁺ | 817 |
| | (Stepan) | | |

Type B: Suitable water soluble surface active polyoxyalkylene polymers and preferably block polymeric compounds containing polyoxypropylene blocks (block A) and polyoxyethylene blocks (block B) or block polymers with multiple polyoxyethylene-polyoxypropylene blocks connected together by an organic moiety whereby there is a minimum of about 40% polyethyleneoxide blocks in the molecule. The block copolymers may be connected in the following manner; A-B-A, B-A-B, A-B, (A-B)n==G==(B-A) or (B-A)n==G==(A-B), wherby G is a connective organic moiety and n is between 1 and 3.

TABLE B
Examples of Type B surfactants useful in the present invention.

| | | | Percent | |
|---|---|---|---|---|
| | | | ethylene | Molecular |
| ID | Manufacturer | Structure | oxide | Weight |
| B-1 | Pluronic L- 44(BASF) | 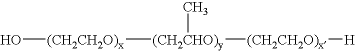 | 40 | 2200 |
| B-2 | Pluronic 17R-4 (BASF) | 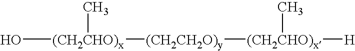 | 40 | 2650 |
| B-3 | Pluronic P- 85 (BASF) | 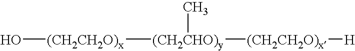 | 50 | 4600 |
| B-4 | Tetronic 704 (BASF) | 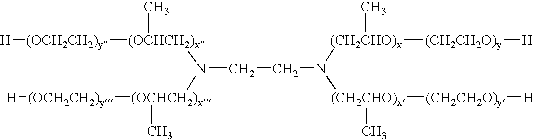 | 40 | 5500 |

Type C: Suitable water soluble surface active polyalkylene oxide-modified polydimethylsiloxanes of the general formula given by (I):

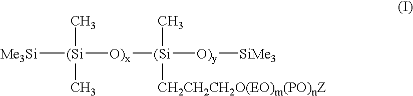

Wherein, EO represents ethylene oxide, PO represents propylene oxide, and Z can be either H or a lower alkyl radical. The values for x and y, along with the values for m and n, determine if the molecule is water soluble or water dispersible. X, y, m, and n may be any value or combination of values that will produce a water soluble or dispersible surfactant and would be calculable using methods known to those of ordinary skill in the art. In a preferred embodiment, the ratio of m:n is at least 60/40. preferably 75:25.

TABLE C
Examples of Type C surfactants useful in the present invention.

| | | Percent | | |
|---|---|---|---|---|
| | | ethylene | | Molecular |
| ID | Manufacturer | oxide | Z | Weight |
| C-1 | Silwet L-7604 | 100 | H | 4000 |
| | (Witco) | | | |
| C-2 | Silwet L-7200 | 75 | H | 19000 |
| | (Witco) | | | |
| C-3 | Silwet L-7607 | 100 | CH₃ | 1000 |
| | (Witco) | | | |

Type D: A suitable water soluble alkylpolyglycoside surfactant represented by the following formula (II):

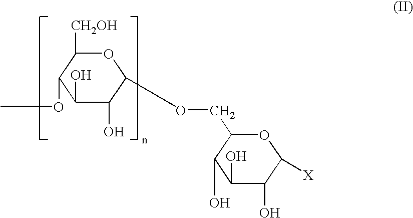

Wherein, n is predominately 0 to 3 carbohydrate units, and X represents a group of type R₁, OR₁, SR₁, or N(R₁)(R₂), where R₁ represents functional groups such as carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide. R₂ may be a hydrogen atom, or represents functional groups such as carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide. Many groups fit under this description of X, but in a particularly useful embodiment, X represents a group OR₁, where R₁ is a linear alkyl chain with an average length comprising 8 or more carbons, more preferably 10 or more carbons and most preferably 12 or more carbons.

TABLE D
Examples of Type D surfactants useful in the present
invention, wherein X represents a group OR₁.

| | | | Average |
|---|---|---|---|
| | | | number of |
| | | Carbons in | carbohydrate |
| ID | Manufacturer | R₁ | units, n |
| D-1 | Glucopon 425 | 8, 10, 12, | 1.5 |
| | (Henkel) | 14, 16 | |
| D-2 | Glucopon 600 | 12, 14, 16 | 1.4 |
| | (Henkel) | | |
| D-3 | Glucopon 625 | 12, 14, 16 | 1.6 |
| | (Henkel) | | |

Examples of other surfactants of class-A, B,C or D set forth in “McCutcheon's”, Vol. 1, “Emulsifiers and Detergents”, International Edition and North American Edition, McCutcheon's Division of the Manufacturing Confectioner Publishing Co., N.J. (1991), incorporated herein by reference, may be used.

The levels at which surfactants of Types A, B, C, or D are typically coated are from 0.2 to 30 mg per square foot of photographic paper, more preferably 2 to 20 mg per square foot, most preferably 5 to 15 mg per square foot.

Used herein, the phrase “imaging element” comprises an imaging support as described above along with an image receiving or recording layer, such as a support for photographic silver halide images. As used herein, the phrase “photographic element” is a material that utilizes photosensitive silver halide in the formation of images.

In another embodiment, in order to produce photographic elements, the composite support sheet may be coated with a photographic element or elements. The photographic elements may be single color elements or multicolor elements. Multicolor elements contain image ink or dye-forming units sensitive to each of the three primary regions of the spectrum. Each unit may comprise a single emulsion layer or multiple emulsion layers sensitive to a given region of the spectrum. The layers of the element, including the layers of the image-forming units, may be arranged in various orders as known in the art. In an alternative format, the emulsions sensitive to each of the three primary regions of the spectrum may be disposed as a single segmented layer.

The photographic emulsions useful for this invention may be generally prepared by precipitating silver halide crystals in a colloidal matrix by methods conventional in the art. The colloid may be typically a hydrophilic film forming agent such as gelatin, alginic acid, or derivatives thereof.

The crystals formed in the precipitation step may be washed and then chemically and spectrally sensitized by adding spectral sensitizing dyes and chemical sensitizers, and by providing a heating step during which the emulsion temperature may be raised, typically from 40° C. to 70° C., and maintained for a period of time. The precipitation and spectral and chemical sensitization methods utilized in preparing the emulsions employed in the invention may be those methods known in the art.

Chemical sensitization of the emulsion typically employs sensitizers such as: sulfur-containing compounds, for example, allyl isothiocyanate, sodium thiosulfate and allyl thiourea, reducing agents, for example, polyamines and stannous salts, noble metal compounds, for example, gold, platinum, and polymeric agents, for example, polyalkylene oxides. As described, heat treatment may be employed to complete chemical sensitization. Spectral sensitization may be effected with a combination of dyes, which are designed for the wavelength range of interest within the visible or infrared spectrum. It is known to add such dyes both before and after heat treatment.

After spectral sensitization, the emulsion may be coated on a support. Various coating techniques include dip coating, air knife coating, curtain coating and extrusion coating.

The silver halide emulsions utilized in this invention may be comprised of any halide distribution. Thus, they may be comprised of silver chloride, silver bromide, silver bromochloride, silver chlorobromide, silver iodochloride, silver iodobromide, silver bromoiodochloride, silver chloroiodobromide, silver iodobromochloride, and silver iodochlorobromide emulsions. By predominantly silver chloride, it is meant that the grains of the emulsion are greater than 50 mole percent silver chloride. Preferably, they are greater than 90 mole percent silver chloride, and optimally greater than 95 mole percent silver chloride.

The silver halide emulsions may contain grains of any size and morphology. Thus, the grains may take the form of cubes, octahedrons, cubo-octahedrons, or any of the other naturally occurring morphologies of cubic lattice type silver halide grains. Further, the grains may be irregular such as spherical grains or tabular or core/shell grains. Grains having a tabular or cubic morphology are preferred.

The photographic elements of the invention may utilize emulsions as described in The Theory of the Photographic Process, Fourth Edition, T. H. James, Macmillan Publishing Company, Inc., 1977, pages 151-152. Reduction sensitization has been known to improve the photographic sensitivity of silver halide emulsions. While reduction sensitized silver halide emulsions generally exhibit good photographic speed, they often suffer from undesirable fog and poor storage stability.

Reduction sensitization may be performed intentionally by adding reduction sensitizers, chemicals that reduce silver ions to form metallic silver atoms, or by providing a reducing environment such as high pH (excess hydroxide ion) and/or low pAg (excess silver ion). During precipitation of a silver halide emulsion, unintentional reduction sensitization may occur when, for example, silver nitrate or alkali solutions may be added rapidly or with poor mixing to form emulsion grains. Also, precipitation of silver halide emulsions in the presence of ripeners (grain growth modifiers) such as thioethers, selenoethers, thioureas, or ammonia tends to facilitate reduction sensitization.

Examples of reduction sensitizers and environments which may be used during precipitation or spectral/chemical sensitization to reduction sensitize an emulsion include ascorbic acid derivatives, tin compounds, polyamine compounds, and thiourea dioxide-based compounds described in U.S. Pat. Nos. 2,487,850; 2,512,925; and British Patent 789,823. Specific examples of reduction sensitizers or conditions, such as dimethylamineborane, stannous chloride, hydrazine, high pH (pH 8-11) and low pAg (pAg 1-7) ripening are discussed by S. Collier in Photographic Science and Engineering, 23, 113 (1979). Examples of processes for preparing intentionally reduction sensitized silver halide emulsions are described in EP 0 348 934 A1 (Yamashita), EP 0 369 491 (Yamashita), EP 0 371 388 (Ohashi), EP 0 396 424 A1 (Takada), EP 0 404 142 A1 (Yamada), and EP 0 435 355 A1 (Makino).

The photographic elements of this invention may use emulsions doped with Group VII metals such as iridium, rhodium, osmium, and iron as described in Research Disclosure, September 1994, Item 36544, Section I, published by Kenneth Mason Publications, Ltd., Dudley Annex, 12a North Street, Emsworth, Hampshire PO 10 7DQ, ENGLAND. Additionally, a general summary of the use of iridium in the sensitization of silver halide emulsions is contained in Carroll, “Iridium Sensitization: A Literature Review,” Photographic Science and Engineering, Vol. 24, No. 6, 1980. A method of manufacturing a silver halide emulsion by chemically sensitizing the emulsion in the presence of an iridium salt and a photographic spectral sensitizing dye is described in U.S. Pat. No. 4,693,965. In some cases, when such dopants are incorporated, emulsions show an increased fresh fog and a lower contrast sensitometric curve when processed in the color reversal E-6 process as described in The British Journal of Photography Annual, 1982, pages 201-203.

A typical multicolor photographic element comprises the invention laminated support bearing a cyan ink or dye image-forming unit comprising at least one red-sensitive silver halide emulsion layer having associated therewith at least one cyan dye-forming coupler, a magenta image-forming unit comprising at least one green-sensitive silver halide emulsion layer having associated therewith at least one magenta dye-forming coupler, and a yellow dye image-forming unit comprising at least one blue-sensitive silver halide emulsion layer having associated therewith at least one yellow dye-forming coupler. The element may contain additional layers, such as filter layers, interlayers, overcoat layers, and subbing layers. The support or base useful with the invention may also be utilized for black and white photographic print elements.

The photographic elements may also contain a transparent magnetic recording layer such as a layer containing magnetic particles on the underside of a transparent support, as in U.S. Pat. Nos. 4,279,945 and 4,302,523. The invention may be utilized with the materials disclosed in Research Disclosure, September 1997, Item 40145. The invention may be particularly suitable for use with the material color paper examples of sections XVI and XVII. The couplers of section II may also be particularly suitable. The Magenta I couplers of section II, particularly M-7, M-10, M-18, and M-18, set forth below may be particularly desirable. In the following Table, reference will be made to (1) Research Disclosure, December 1978, Item 17643, (2) Research Disclosure, December 1989, Item 308119, and (3) Research Disclosure, September 1994, Item 36544, all published by Kenneth Mason Publications, Ltd., Dudley Annex, 12a North Street, Emsworth, Hampshire PO10 7DQ, ENGLAND. Table 1 and the references cited in Table 1 are to be read as describing particular components suitable for use in the elements of the invention. The Table and its cited references also describe suitable ways of preparing, exposing, processing and manipulating the elements and the images contained therein.

TABLE 1

| Reference | Section | Subject Matter |
|---|---|---|
| 1 | I, II | Grain composition, |
| 2 | I, II, IX, X, XI, | morphology and preparation. |
| | XII, XIV, XV | Emulsion preparation including |
| | I, II, III, IX | hardeners, coating aids, |
| 3 | | A & B addenda, etc. |
| 1 | III, IV | Chemical sensitization and |
| 2 | III, IV | spectral sensitization |
| 3 | IV, V | Desensitization. |
| 1 | V | UV dyes, optical brighteners, |
| 2 | V | luminescent dyes |
| 3 | VI | |
| 1 | VI | Antifoggants and stabilizers |
| 2 | VI | |
| 3 | VII | |
| 1 | VIII | Absorbing and scattering |
| 2 | VIII, XIII, XVI | materials; Antistatic layers; |
| 3 | VIII, IX | C & D matting agents |
| 1 | VII | Image-couplers and image- |
| 2 | VII | modifying couplers; Dye |
| 3 | X | stabilizers and hue modifiers |
| 1 | XVII | Supports |
| 2 | XVII | |
| 3 | XV | |
| 3 | XI | Specific layer arrangements |
| 3 | XII, XIII | Negative working emulsions; |
| | | Direct positive emulsions |
| 2 | XVIII | Exposure |
| 3 | XVI | |
| | I XIX, XX | Chemical processing; |
| 2 | XIX, XX, XXII | Developing agents |
| 3 | XVIII, XIX, XX | |
| 3 | XIV | Scanning and digital |
| | | processing procedures |

The photographic elements may be exposed with various forms of energy which encompass the ultraviolet, visible, and infrared regions of the electromagnetic spectrum as well as with electron beam, beta radiation, gamma radiation, x-ray, alpha particle, neutron radiation, and other forms of corpuscular and wave-like radiant energy in either noncoherent (random phase) forms or coherent (in phase) forms, as produced by lasers. When the photographic elements are intended to be exposed by x-rays, they may include features found in conventional radiographic elements.

The photographic elements may be preferably exposed to actinic radiation, typically in the visible region of the spectrum, to form a latent image, and then processed to form a visible image, preferably by other than heat treatment. Processing may be preferably carried out in the known RA-4.TM. (Eastman Kodak Company) Process or other processing systems suitable for developing high chloride emulsions. In one embodiment, this invention may be directed towards a photographic recording element comprising a support and at least one light sensitive silver halide emulsion layer comprising silver halide grains as described above.

For the image recording element of this invention utilized as a display material, at least one image layer containing silver halide and a dye forming coupler located on the top side or bottom side of the imaging element may be preferred. Applying the imaging layer to either the top or bottom may be preferred for a quality photographic transmission display material. For some markets improved image quality requires an increase in dye density. Increasing dye density increases the amount of light sensitive silver halide emulsion coated on one side. While the increase in emulsion coverage does improve image quality, developer time may be increased from 50 seconds to 110 seconds. For the image recording element of this invention, when used as a display material, it is preferred that at least one image layer comprising at least one dye forming coupler is located on both the top and bottom of the imaging support used with this invention is preferred. Applying an image layer to both the top and bottom of the support allows for optimization of image density with thinner photosensitive layers while allowing for developer time less than 50 seconds.

The image recording element, when used as a display material, wherein at least one dye forming layer on the top side comprises about the same amount of dye forming coupler of the imaging layer on the backside is most preferred. Coating substantially the same amount of light sensitive silver halide emulsion on both sides has the additional benefit of balancing the imaging element for image curl caused by the contraction and expansion of the hydroscopic gel typically utilized in photographic emulsions.

The surfactant may be present in any of the imaging or non-imaging layers. It is usually preferred to add the surfactant to the melted emulsion or dispersion prior to coating, but may be added earlier, for example, during the preparation of the melts. It is sometimes preferred to put the surfactant in the overcoat or to the interlayers so as not to interfere with the stability of the dispersions and/or emulsions.

The processing solutions used with the present invention are essentially free of fluorescent brightening agents. As previously mentioned, essentially free means that the processing solution contains no intentionally added optical brightening agent, but considers that some insignificant amount may be present as a residual contaminant. Optical brightening agents which are absent may be found in Research Disclosure 20733, page 268 (July, 1981), which describes a method using bis (triazinylamino) stilbene disulfonic acid compounds to remove stains caused by spectral sensitizers. The processing solutions (one or more of the following: developer, bleach, fix, combined bleach-fix, or stabilizer bath) for use in the present invention are substantially free of bis (triazinylamino) stilbene disulfonic acid compound. Bis-triazinylaminostilbene-2,2′-disulfonic acid fluorescent whitening agents which can be used for whitening coating compositions in the process of this invention are, in particular, those of the formula 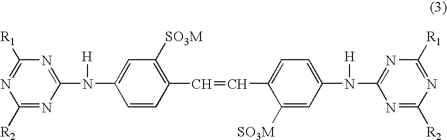
wherein M is hydrogen, or an alkali metal ion, ammonium ion or amine salt ion, and R₁ and R₂ are NH₂, NH—CH₃, NH—C₂H₅, N(CH₃)₂, N(C₂H₅)₂, NH—CH₂—CH₂—OH, NH—CH₂—CH₂—CH₂—OH, N(CH₂—CH₂—OH)₂, N(CH₂—CH₂ CH₂—OH)₂, N(CH₃)(CH₂—CH₂—OH), NH—CH₂—CH₂—O—CH₂—CH₂—OH, NH—CH₂—CH₂—SO₃ M, OH, OCH₃, OCH(CH₃)₂, O—CH₂—CH₂—O—CH₃, 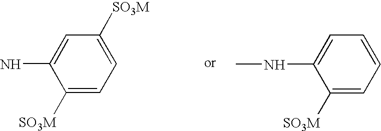
It is preferred to use a fluorescent whitening agent of the formula 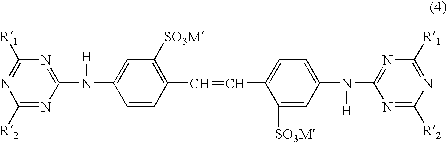
wherein R_{1′} is —NHCH₂ CH₂ OH, —N(CH₂CH₂OH)₂, —N(CH₂ CH₃)₂ or 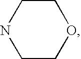
wherein R_{2′} is 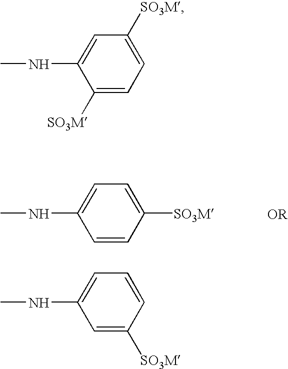
and M′ is hydrogen or an alkali metal ion, an ammonium, diethanolammonium or triethanolammonium ion.

The sulfo groups —SO₃ M in compounds of the formula (3) can be in the free form (M=H) or in salt form. M is then an alkali metal ion, especially a sodium or potassium ion, an ammonium ion or an amine salt ion, e.g. of a primary or secondary alkylamine, the alkyl group or groups of which can be substituted by halogen, hydroxyl (e.g. ethanol amine, di ethanol amine, triethanolamine) or alkoxy, or of a cyclic amine, e.g. a piperidine, pyrrolidine, piperazine or morpholine.

Other examples may be found in EP 1122 598 A2 and Senshoku Note (Dyeing Note), 19^{th} Edition (Shikisensya Co.; Ltd.) pp. 165 to 169. Still other optical brighteners for omission may include the following compounds:

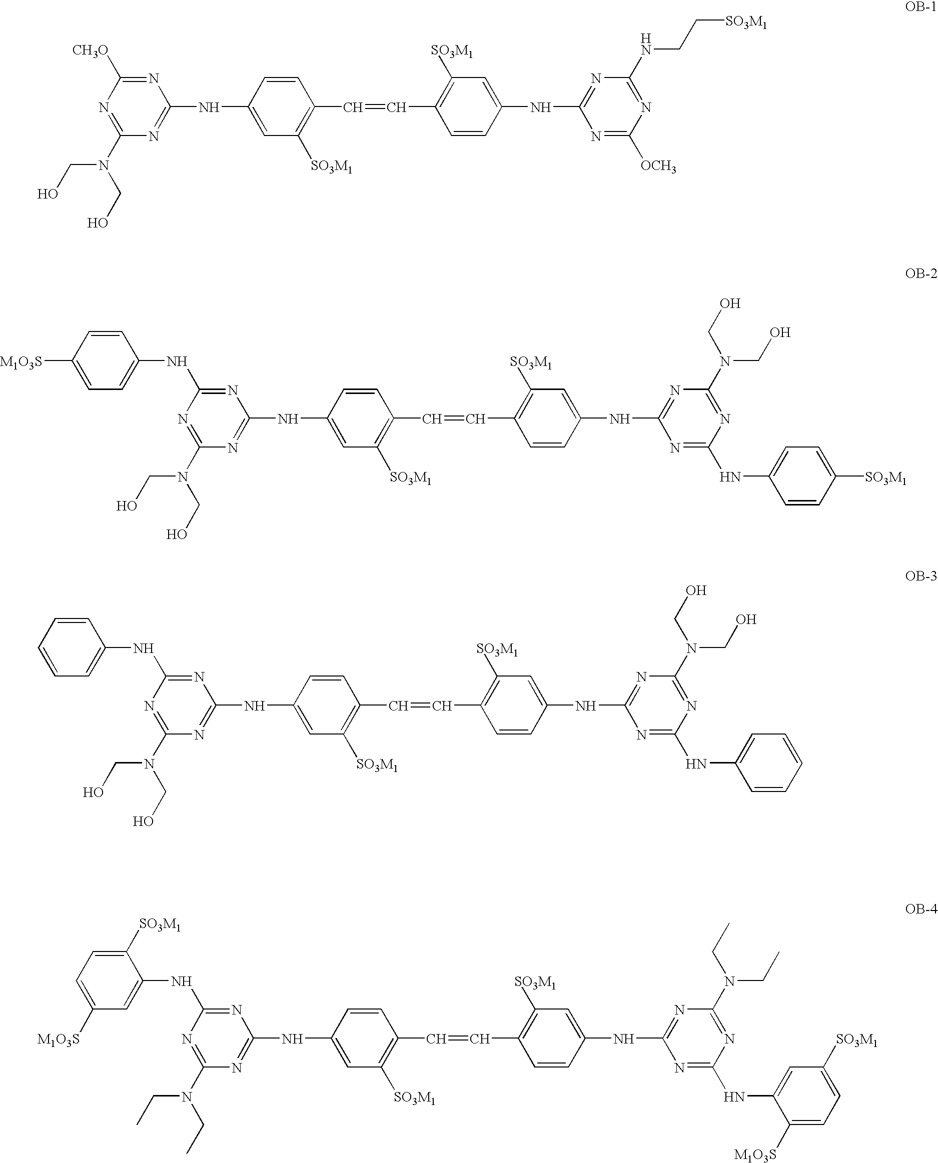

Examples of non-bis (triazinylamino) stilbene disulfonic acid compounds for omission may include compounds which include a triazinyl moiety but lack a stilbene moiety, described in U.S. Pat. No. 6,395,461 02 (col. 3, line 5 to col. 11, line 43).

Another example (OB-5) contains a stilbene moiety but lacks a triazinyl moiety.

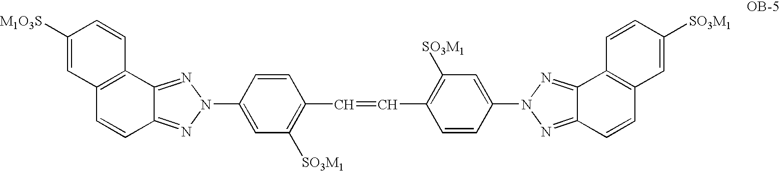

The present invention involves the RA-4 processing method, which typically includes the steps of color developing, and subsequent bleach-fixing without a wash step between color developing and bleach-fixing, and stabilization, and the solutions necessary to accomplish color development and subsequent bleaching, fixation, and stabilization, as disclosed in U.S. Pat. No. 4,892,804, incorporated herein by reference. The bleach-fixing composition is typically a thiosulfate fixing agent and a ferric complex of an aminopolycarboxylic acid, which acts as a bleaching agent, while the stabilizing composition contains an aldehyde as the stabilizing agent. Such a process involves only the three steps of color developing, bleach-fixing, and stabilizing, followed by a short drying step, which results in a very short processing time. Generally, color development is accomplished in from 30 to 60 seconds at a temperature of 30-40 C in a color developing composition having a pH of from 9 to 13 in a solution of primary amino color developing agent, a dialkylhydroxylamine and at least one sequestrant. The bleach-fixing is accomplished in from 30 to 60 seconds at a temperature of 25-40 C in a solution having a pH of from 5 to 8, more preferably 6 to 7. Stabilizing is accomplished in from 60 to 120 seconds at a temperature of from 25-40 C at a pH of from 5 to 8. Adequate drying may be accomplished in about one minute at 60 C. Additional information on components for processing may be found in U.S. Pat. No. 6,664,035, incorporated herein by reference.

Especially useful antioxidants are hydroxylamine derivatives as described for example, in U.S. Pat. No. 4,892,804 (noted above), U.S. Pat. No. 4,876,174 (noted above), U.S. Pat. No. 5,354,646 (noted above), U.S. Pat. No. 5,660,974 (noted above), U.S. Pat. No. 5,709,982 (Marrese et al.), and U.S. Pat. No. 5,646,327 (Burns et al.), the disclosures of which are all incorporated herein by reference with respect to antioxidants. Many of these antioxidants are mono- and dialkylhydroxylamines having one or more substituents on one or both alkyl groups. Particularly useful alkyl substituents include sulfo, carboxy, amino, sulfonamido, carbonamido, hydroxy and other solubilizing substituents. The most preferred hydroxylamine derivatives comprise one or more sulfo, carboxy, or hydroxy solubilizing groups. Some representative hydroxylamine derivative antioxidants include N,N-diethylhydroxylamine, N-isopropyl-N-ethylsulfonatohydroxylamine, and N,N-diethylsulfonatohydroxylamine.

Color developing agents are well known in the art as compounds that, in oxidized form, will react with dye forming color couplers in the processed photographic materials. Such color developing agents include, but are not limited to, aminophenols, p-phenylenediamines (especially N,N-dialkyl-p-phenylenediamines) and others which are well known in the art, such as EP 0 434 097A1 (published Jun. 26, 1991) and EP 0 530 921A1 (published Mar. 10, 1993). It may be useful for the color developing agents to have one or more water-solubilizing groups as are known in the art. Further details of such materials are provided in Research Disclosure, publication 38957, pages 592-639 (September 1996).

Preferred color developing agents include, but are not limited to, N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-β-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), 4-(N-ethyl-N-2-methanesulfonylaminoethyl)-2-methylphenylenediamine sesquisulfate, and others readily apparent to one skilled in the art. In some embodiments, the color developing agents can be used in “free base form” as described in U.S. Pat. No. 6,077,651 (noted above).

Another optional component of one or more aqueous solutions of color developing compositions is a polycarboxylic acid, or salt thereof, or polyphosphonic acid, or salt thereof, as a calcium ion or other metal ion sequestering or chelating agent. Mixtures of these compounds can also be used. There are many such compounds known in the art including U.S. Pat. No. 4,546,068 (Kuse), U.S. Pat. No. 4,596,765 (Kurematsu et al.), U.S. Pat. No. 4,892,804 (noted above), U.S. Pat. No. 4,975,357 (Buongiome et al.), U.S. Pat. No. 5,034,308 (Abe et al.), and Research Disclosure publications Item 20405 (April, 1981), Item 18837 (December, 1979), Item 18826 (December, 1979), and Item 13410 (December, 1975).

Phosphonic acid metal ion sequestering agents are well known in the art, and are described for example in U.S. Pat. No. 4,596,765 (noted above) and Research Disclosure publications Item 13410 (June, 1975), 18837 (December, 1979), and 20405 (April, 1981).

Useful metal ion sequestering agents are readily available from a number of commercial sources. Particularly useful phosphonic acids are the disphosphonic acids (and salts thereof) and polyaminopolyphosphonic acids (and salts thereof) described below. It is preferable to use one or more compounds of these classes in combination. Useful disphosphonic acids include hydroxyalkylidene disphosphonic acids, aminodiphosphonic acids, amino-N,N-dimethylenephosphonic acids, and N-acyl aminodisphosphonic acids.

Particularly useful polyphosphonic acids, and salts thereof, may include polyaminopolyphosphonic acid (or salt thereof) that has at least five phosphonic acid (or salt) groups. A mixture of such compounds can be used if desired. Suitable salts include ammonium and alkali metal ions salts.

Preferred compounds of this nature can be represented by the following Structure III: 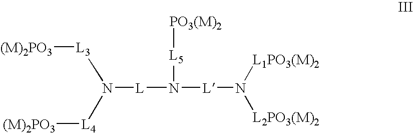
wherein L, L′, L₁, L₂, L₃, L₄ and L₅ are independently substituted or unsubstituted divalent aliphatic linking groups, each independently having 1 to 4 carbon, oxygen, sulfur or nitrogen atoms in the linking group chain. Preferably, these substituted or unsubstituted divalent linking groups have 1 to 4 carbon atoms in the linking group chain (such as substituted or unsubstituted branched or linear alkylene groups). More preferably, the divalent linking groups are independently substituted or unsubstituted methylene or ethylene. Most preferably, L and L′ are each substituted or unsubstituted ethylene (preferably unsubstituted), and each of the other linking groups is an unsubstituted methylene group. M is hydrogen or a monovalent cation (such as ammonium ion or an alkali metal salt).

The noted divalent groups can be substituted with any substituent that does not interfere with the desired performance of the sequestering agent, or with the photochemical properties of the color developing compositions. Such substituents include, but are not limited to, hydroxy, sulfo, carboxy, halo, lower alkoxy (1 to 3 carbon atoms) or amino.

A particularly useful sequestering agent of this type is diethylenetriaminepentamethylenephosphosphonic acid or an alkali metal salt thereof (available as DEQUEST™ 2066 from Solutia Co.).

Still another optional but preferred sequestering agent is a diphosphonic acid (or salt thereof) that includes hydroxyalkylidene diphosphonic acids (or salts thereof). Mixtures of such compounds can be used if desired. Useful salts include the ammonium and alkali metal ion salts.

Preferred hydroxyalkylidene diphosphonic acids (or salts thereof) can be represented by the following Structure IV: 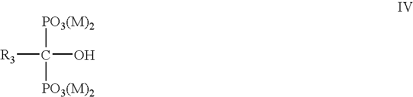
wherein R₃ is a substituted or unsubstituted alkyl group having 1 to 5 carbon atoms (methyl, methoxymethyl, ethyl, isopropyl, n-butyl, t-butyl and n-pentyl) and M is hydrogen or a monovalent cation (such as ammonium or alkali metal ions). Preferably, R₃ is methyl or ethyl, and most preferably, it is ethyl.

Representative sequestering agents of this class include, but are not limited to, 1-hydroxyethylidene-1,1-diphosphonic acid, 1-hydroxy-n-propylidene-1,1-diphosphonic acid, 1-hydroxy-2,2-dimethylpropylidene-1,1-diphosphonic acid and others that would be readily apparent to one skilled in the art (and alkali metal and ammonium salts thereof). The first compound is most preferred and is available as DEQUEST™ 2010, and its tetrasodium salt is available as DEQUEST™ 2016D, both from Solutia Co. Another useful sequestering agent is morpholinomethanediphosphonic acid or a salt thereof that is available as BUDEX™ 5103 from Budenheim (Germany). This and similar cyclic aminodiphosphonic acids (and salts thereof) are described in U.S. Pat. No. 4,873,180 (Marchesano et al.).

It is also possible to include other metal ion sequestering agents (for example, for iron, copper or manganese ion sequestration) in one or more aqueous solutions.

The photographic elements processed in the practice of this invention can be single or multilayer color elements. Multilayer color elements typically contain dye image-forming units sensitive to each of the three primary regions of the visible spectrum. Each unit can be comprised of a single emulsion layer or multiple emulsion layers sensitive to a given region of the spectrum. The layers of the element can be arranged in any of the various orders known in the art. In an alternative format, the emulsions sensitive to each of the three primary regions of the spectrum can be disposed as a single segmented layer. The elements can also contain other conventional layers such as filter layers, interlayers, subbing layers, overcoats and other layers readily apparent to one skilled in the art. A magnetic backing can be included on the backside of conventional supports.

If the present invention is used to process color photographic papers, those papers generally include high chloride (greater than 70 mole % chloride and preferably greater than 90 mole % chloride, based on total silver) emulsions. Such color photographic papers can have any useful amount of silver coated in the one or more emulsions layers, and in some embodiments, low silver (that is, less than about 0.8 g silver/m²) elements can be processed with the present invention.

Color development of an imagewise exposed photographic silver halide element is carried out by contacting the element with a working strength color developing composition prepared according to this invention under suitable time and temperature conditions and in suitable processing equipment, to produce the desired developed color images. Additional processing steps can then be carried out using conventional procedures, including but not limited to, one or more development stop, desilvering steps (such as bleaching, fixing, or bleach/fixing), washing (or rinsing), stabilizing and drying steps, in any particular desired order as would be known in the art. Useful processing steps, conditions and materials useful therein are well known for the various processing protocols including the conventional Process C-41 processing of color negative films, Process RA-4 for processing color papers and Process E-6 for processing color reversal films (see for example, Research Disclosure publication 38957 noted above).

More details of the element structure and components, and suitable methods of processing various types of elements are described in Research Disclosure publication 38957 (noted above). Included within such teachings is the use of various classes of cyan, yellow and magenta color couplers that can be used with the present invention (including pyrazolone and pyrazolotriazole type magenta dye forming couplers.

In a preferred embodiment, the working strength color developing composition prepared according to this invention is brought into contact with the imagewise exposed color photographic silver halide material in any suitable fashion in a processing tank. Alternatively, the processing composition can be sprayed onto the material using suitable application devices. Without removing the material from the color developing composition, it is then subjected to desilvering, that is removal of silver. This can be done with one or more steps, including a bleaching step following by a fixing step, a fixing step followed by a bleaching step and/or a fixing step, a single bleach/fixing step, or any combination thereof. It is essential in this embodiment that the desilvering step(s) be carried out without removing the color photographic silver halide material from the working strength color developing composition. In other words, the desilvering composition(s) are added to the color developing composition after a sufficient time for color development, or sprayed onto the material without removing the color developing composition.

Numerous bleaching agents are known in the art, including hydrogen peroxide and other peracid compounds, persulfates, periodates and ferric ion salts or complexes with polycarboxylic acid chelating ligands. Particularly useful chelating ligands include conventional polyaminopolycarboxylic acids including ethylenediaminetetraacetic acid and others described in Research Disclosure publication 38957 noted above, U.S. Pat. No. 5,582,958 (Buchanan et al.) and U.S. Pat. No. 5,753,423 (Buongiome et al.). Biodegradable chelating ligands are also desirable because the impact on the environment is reduced. Useful biodegradable chelating ligands include, but are not limited to, iminodiacetic acid or an alkyliminodiacetic acid (such as methyliminodiacetic acid), ethylenediaminedisuccinic acid and similar compounds as described in EP-A-0 532,003 (Ueda et al.), and ethylenediamine monosuccinic acid and similar compounds as described in U.S. Pat. No. 5,691,120 (Wilson et al.).

Useful fixing agents are also well known in the art and include various thiosulfates and thiocyanates or mixtures thereof as described for example in U.S. Pat. No. 6,013,424 (Schmittou et al.).

Rinsing and/or stabilizing steps can be carried out after desilvering if desired using various rinsing or stabilizing compositions that may include one or more anionic or nonionic surfactants. Representative compositions for this purpose are, for example, described in U.S. Pat. No. 5,534,396 (McGuckin et al.), U.S. Pat. No. 5,578,432 (McGuckin et al.), U.S. Pat. No. 5,645,980 (McGuckin et al.), U.S. Pat. No. 5,667,948 (McGuckin et al.), and U.S. Pat. No. 5,716,765 (McGuckin et al.).

The processing time and temperature used for each processing step of the present invention can be those conventionally used in the art. For example, color development and desilvering can be generally carried out independently at temperatures of from about 20 to about 60° C. The overall color development time can be up to 40 minutes, and preferably from about 75 to about 450 seconds. More preferably, the color development time is from about 30 to about 90 seconds when processing color negative films. Even shorter color development times may be used for processing color photographic papers.

Desilvering can be carried out for from about 30 to about 480 seconds using one or more bleaching, fixing, or bleach/fixing steps. Preferably, a fixing step is carried out for from about 20 to about 240 seconds followed by a bleaching step for from about 20 to about 240 seconds.

Processing according to the present invention can be carried out using any suitable processing machine including those having deep tanks for holding processing solutions. Alternatively, it can be carried out using what is known in the art as “low volume thin tank” processing systems, or LVTT, which have either a rack and tank or automatic tray design. These processors are sometimes known as “minilab” processing machines. Such processing methods and equipment are described, for example, in U.S. Pat. No. 5,436,118 (Carli et al.) and publications noted therein. Some useful minilab processing machines are commercially available as Noritsu 2211SM Printer/Paper Processor, Noritsu 2102SM Printer/Paper Processor and Noritsu 2301SM Printer/Paper Processor.

The processing apparatus can also include various processing equipment, metering devices, processing instructions, silver recovery devices and other conventional materials as would be readily apparent to one skilled in the art.

### EXAMPLES

The following examples are provided to illustrate the invention. In the examples of processing methods given below, it will be noted that the color developing agent (such as 3-methyl-4amino-N-ethyl-N-(b-methanesulfonamidoethyl)aniline), or the antioxidant (such as N,N-diethylhydroxylamine) are absent from the developing solution. While this processing does not represent true development of the light-sensitive material, it is well known to those experienced in the photographic art that the presence or absence of these components in the developer leads to neither a beneficial nor harmful effect on actual measured levels of retained dye. However, the presence of color developer and hence also the needed antioxidant leads to non-imagewise silver and dye density (sometimes described as fog) which may obscure visual and colorimetric comparisons of the processed light-sensitive coatings for unwanted coloration that is due solely to retained sensitizing dye.

Coating Composition Information

The following compounds were used in the coating compositions which follow.

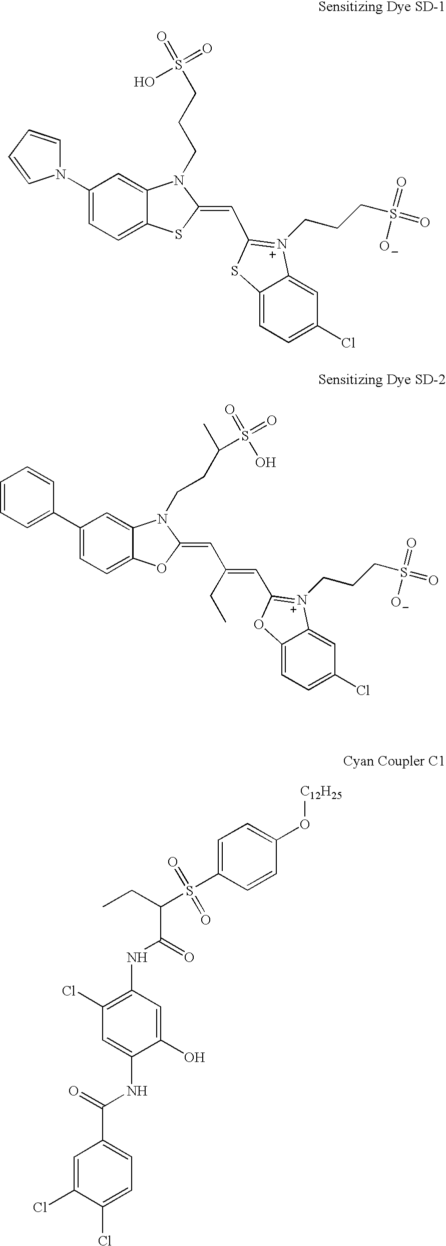

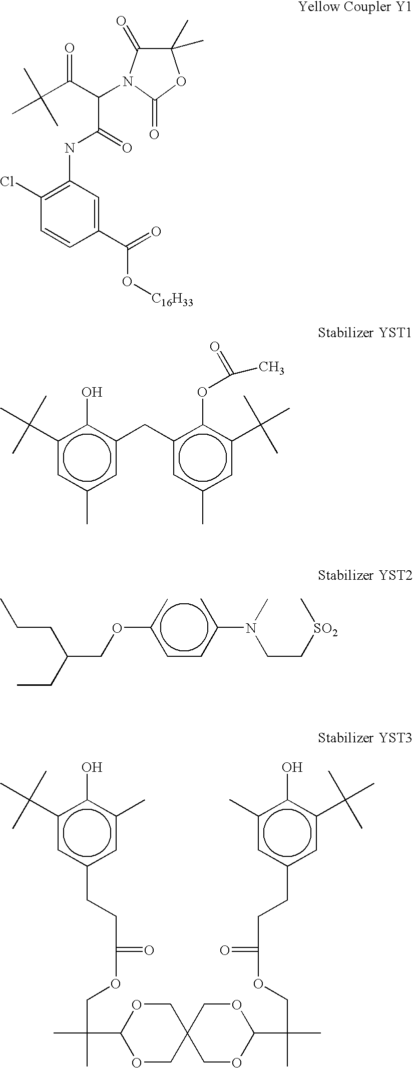

The following dispersion compositions were prepared for the coating compositions which follow.

Dispersion 1 was prepared by dissolving coupler C1 in a mixture of di-n-butyl sebacate, tris-2-ethylhexyl phosphate and Tinuvin-328 (Ciba Specialty Chemicals) and heating to dissolution. The hot oil phase solution was mixed with an aqueous solution compromising; gelatin a 10% solution of di-isopropyl/triisopropyl naphthalene-sulphonic acid (sodium salts) and water. The oil was dispersed into the gelatin phase using a multiple orifice homogenizer at 5000 psi.

Dispersion 2 was prepared by dissolving dioctyl hydroquinone in a mixture of tri-cresyl phosphate and Irganox 1076 (Ciba Specialty Chemicals) and heating to dissolution. The hot oil phase solution was mixed with an aqueous solution compromising; gelatin, a 10% solution of di-isopropyl/triisopropyl naphthalene-sulphonic acid (sodium salts) and water. The oil was dispersed into the gelatin phase using a multiple orifice homogenizer at 5000 psi.

Dispersion 3 was prepared by dissolving coupler Y1 in a mixture of stabilizers, YST1, YST2, YST3 and tributyl citrate and heating to dissolution. The hot oil phase solution was mixed with an aqueous solution compromising; gelatin a 10% solution of di-isopropyl/triisopropyl naphthalene-sulphonic acid (sodium salts) and water. The oil was dispersed into the gelatin phase using a multiple orifice homogenizer at 5000 psi.

Each of these coupler dispersions was diluted with further aqueous gelatin and coated in one of coating strucutures; CS-1, CS-2, or CS-3 shown below. A blue-sensitive cubic silver chloride photographic emulsion was spectrally sensitized with sensitizing dye SD-1 and a green-sensitive cubic silver chloride photographic emulsion spectrally sensisitized with sensitizing dye SD-2 were used for coating on a resin-coated paper support, pre-coated with an unhardened gel pad. The mixing of the already molten components was carried out immediately prior to coating. A protective gel layer, which contained an appropriate quantity of bis-(vinylsulphonylmethane) hardener, was coated over the photosensitive layer. The full coating structures are shown below where Alkanol XC (Dupont) is di-isopropyl/triisopropyl naphthalene-sulphonic acid (sodium salts) and FT-248 (Bayer Chemical Corporation) is tetraethylammonium perfluorooctane sulfonate.

### Coating Structure CS-1

GEL SUPERCOAT

| | | |
|---|---|---|
| Gelatin | 1.077 | g · m⁻² |
| Alkanol XC | 25.6 | mg · m⁻² |
| FT-248 | 10.8 | mg · m⁻² |

CYAN IMAGE COUPLER LAYER

| | | |
|---|---|---|
| Gelatin | 1.560 | g · m⁻² |
| Coupler C1 | 0.387 | g · m⁻² |
| Inventive surfactant (if present) | 0.118 | g · m⁻² |

SILVER BEARING LAYER

| | | |
|---|---|---|
| Hardener* | 0.137 | g · m⁻² |
| Gelatin | 1.312 | g · m⁻² |
| Ag with SD-1 | 0.323 | g · m⁻² |

GEL PAD

| | | |
|---|---|---|
| Gelatin | 3.230 | g · m⁻² |

Resin Coated Paper
*Hardener = bis(vinylsulphonylmethane)

### Coating Structure CS-2

GEL SUPERCOAT

| | | |
|---|---|---|
| Gelatin | 1.077 | g · m⁻² |
| Alkanol XC | 25.6 | mg · m⁻² |
| FT-248 | 10.8 | mg · m⁻² |

CYAN IMAGE COUPLER LAYER

| | | |
|---|---|---|
| Gelatin | 1.560 | g · m⁻² |
| Coupler C1 | 0.245 | g · m⁻² |
| Inventive surfactant (if present) | 0.118 | g · m⁻² |

INTERLAYER

| | | |
|---|---|---|
| Dioctyl hydroquinone | 0.108 | g · m⁻² |
| Gelatin | 1.076 | g · m⁻² |

SILVER BEARING LAYER

| | | |
|---|---|---|
| Hardener* | 0.143 | g · m⁻² |
| Gelatin | 1.312 | g · m⁻² |
| Ag with SD-1 or SD-2 | 0.323 | g · m⁻² |

GEL PAD

| | | |
|---|---|---|
| Gelatin | 3.230 | g · m⁻² |

Resin Coated Paper
*Hardener = bis(vinylsulphonylmethane)

### Coating Structure CS-3

Coating Structure CS-3
GEL SUPERCOAT

| | | |
|---|---|---|
| Gelatin | 1.077 | g · m⁻² |
| Alkanol XC | 25.6 | mg · m⁻² |
| FT-248 | 10.8 | mg · m⁻² |
| Hardener* | 0.125 | g · m⁻² |

CYAN IMAGE COUPLER LAYER

| | | |
|---|---|---|
| Gelatin | 1.399 | g · m⁻² |
| Coupler C1 | 0.323 | g · m⁻² |
| Inventive surfactant (if present) | 0.118 | g · m⁻² |

SILVER BEARING LAYER

| | | |
|---|---|---|
| Coupler Y1 | 0.431 | g · m⁻² |
| Gelatin | 0.829 | g · m⁻² |
| Ag with SD-1 | 0.269 | g · m⁻² |

GEL PAD

| | | |
|---|---|---|
| Gelatin | 3.230 | g · m⁻² |

*Hardener = bis(vinylsulphonylmethane)
Resin Coated Paper

General Processing

Processing was carried out in a deep tank processor using EKTACOLOR Process RA-4 conditions, with steps as follows:

| | | |
|---|---|---|
| Development | 38° C. | 45 seconds |
| Bleach/fixing | 38° C. | 45 seconds |
| Washing/Stabilizing | 35° C. | 90 seconds |

The development step is performed as described below for Processing Methods A-B use a developer that is a modified version of commercially available KODAK EKTACOLOR RA-12 Developer. KODAK EKTACOLOR RA-12 Developer is similar to that described in Table 2, except that the color developing agent CD-3 and antioxidant N,N-diethylhydroxylamine are not absent. Bleach/fixing was carried out using commercially available KODAK EKTACOLOR RA-4 Bleach-Fix (Table 2) and the washing step was carried out using tap water. For the data shown in Table 5, 1 g/L of a surfactant (as noted) was added to the process solutions before processing.

Processing Methods A-B were used to compare the effect of dye stain in light-sensitive coatings when BLANKOPHOR REU was included or excluded from developer solutions, with surfactant introduced either during the coating procedure or in processing solutions.

Processing Method A:

TABLE 1
Components of developer solution for Processing Method A

| | Total | Unit of |
|---|---|---|
| Components | Amount | Measure |
| Water | 500 | mL |
| VERSA TL | 0.284 | grams |
| Lithium Sulfate | 2.500 | grams |
| Potassium Sulfite 45% | 0.786 | grams |
| KODAK ANTI-CAL #5 60% | 1.147 | grams |
| Potassium Bromide | 0.034 | grams |
| Potassium Chloride | 5.796 | grams |
| Potassium Carbonate | 25.000 | grams |
| To volume with water, | 1000 | mL |
| pH adjusted to 10.1 | | |

TABLE 2
Components of bleach-fix solution for Process Method A

| | Total | Unit of |
|---|---|---|
| Components | Amount | Measure |
| Ammonium sulfite | 58 | grams |
| Sodium thiosulfate | 8.7 | grams |
| Ethylenedieminetetraacetic | 40 | grams |
| acid ferric ammonium salt | | |
| Acetic acid | 9.0 | mL |
| To volume with water, | 1000 | mL |
| pH adjusted to 6.2 | | |

Processing Method B:

TABLE 3
Components of developer solution for Processing Method B

| | Total | Unit of |
|---|---|---|
| Components | Amount | Measure |
| Water | 500 | mL |
| VERSA TL | 0.284 | grams |
| Lithium Sulfate | 2.500 | grams |
| Potassium Sulfite 45% | 0.786 | grams |
| KODAK ANTI-CAL #5 60% | 1.147 | grams |
| Potassium Bromide | 0.034 | grams |
| Potassium Chloride | 5.796 | grams |
| Potassium Carbonate | 25.000 | grams |
| BLANKOPHOR REU | 0.644 | grams |
| To volume with water, | 1000 | mL |
| pH adjusted to 10.1 | | |

Bleach-fixing for processing method B used the same formula as used for processing method A. This bleach-fix is described in Table 3.

TABLE 4
Results of processing bilayer coatings using processing methods A and B.

| | Spectral | | | | |
|---|---|---|---|---|---|
| | sensitizing | Coated Surfactant | Process Method | Retained Spectral | |
| Coating | dye and laydown, | (11 mg/ft², if | (A = No REU, | Sensitizing Dye After | |
| Structure | (μg/ft²) | present) | B = REU) | Processing (μg/ft²) | Note |
| CS-2 | SD-1, 75 | None | A | 59.1 | Comparison |
| CS-2 | SD-1, 75 | None | B | 51.9 | Comparison |
| CS-1 | SD-1, 75 | None | A | 59.7 | Comparison |
| CS-1 | SD-1, 75 | None | B | 45.1 | Comparison |
| CS-1 | SD-1, 75 | PLURONIC L-44 | A | 4.2 | Invention |
| CS-1 | SD-1, 75 | PLURONIC L-44 | B | 41.6 | Comparison |
| CS-1 | SD-1, 75 | PLURONIC L-44 | A | 9.3 | Invention |
| CS-1 | SD-1, 75 | PLURONIC L-44 | B | 31.8 | Comparison |
| CS-1 | SD-1, 75 | PLURONIC P-85 | A | 8.0 | Invention |
| CS-1 | SD-1, 75 | PLURONIC P-85 | B | 27.2 | Comparison |
| CS-1 | SD-1, 75 | PLURONIC 17R4 | A | 6.4 | Invention |
| CS-1 | SD-1, 75 | PLURONIC 17R4 | B | 29.0 | Comparison |
| CS-1 | SD-1, 75 | TETRONIC 704 | A | 6.9 | Invention |
| CS-1 | SD-1, 75 | TETRONIC 704 | B | 28.3 | Comparison |
| CS-1 | SD-1, 75 | BRIJ 97 | A | 5.1 | Invention |
| CS-1 | SD-1, 75 | BRIJ 97 | B | 30.6 | Comparison |
| CS-1 | SD-1, 75 | SILWET L7604 | A | 37.0 | Invention |
| CS-1 | SD-1, 75 | SILWET L7604 | B | 29.8 | Comparison |
| CS-1 | SD-1, 75 | TERGITOL 15S15 | A | 5.0 | Invention |
| CS-1 | SD-1, 75 | TERGITOL 15S15 | B | 24.9 | Comparison |
| CS-2 | SD-2, 100 | None | A | 57.9 | Comparison |
| CS-2 | SD-2, 100 | None | B | 33.4 | Comparison |
| CS-2 | SD-2, 100 | PLURONIC L-44 | A | 9.4 | Invention |
| CS-2 | SD-2, 100 | PLURONIC L-44 | B | 12.7 | Comparison |

The results in Table 4 show that the presence of a surfactant in the imaging element reduces the dye stain (as measured by retained sensitizing dye after processing) compared to coatings where the surfactant is absent, and also shows the unexpected effect that the lowest dye stain levels are often achieved when the processing solution does not contain a dye washout agent (such as PHORWITE REU).

TABLE 5
Results of processing bilayer coatings with no coated surfactant,
but with surfactant introduced into the processing solutions.

| | Spectral | | | | |
|---|---|---|---|---|---|
| | sensitizing | PLURONIC L-44 (if | Process Method | Retained Spectral | |
| Coating | dye and laydown, | present): 1 g/L in | (A = No REU, | Sensitizing Dye After | |
| Structure | (μg/ft²) | processing solution | B = REU) | Processing (μg/ft²) | Note |
| CS-2 | SD-1, 75 | None | A | 66.2 | Comparison |
| CS-2 | SD-1, 75 | None | A | 38.4 | Comparison |
| CS-2 | SD-1, 75 | None | B | 28.7 | Comparison |
| CS-2 | SD-1, 75 | None | B | 30.8 | Comparison |
| CS-2 | SD-2, 100 | None | A | 83.6 | Comparison |
| CS-2 | SD-2, 100 | None | A | 86.1 | Comparison |
| CS-2 | SD-2, 100 | None | B | 39.1 | Comparison |
| CS-2 | SD-2, 100 | None | B | 36.8 | Comparison |
| CS-2 | SD-1, 75 | Developer only | A | 49.9 | Comparison |
| CS-2 | SD-1, 75 | Developer only | B | 20.4 | Comparison |
| CS-2 | SD-2, 100 | Developer only | A | 45.3 | Comparison |
| CS-2 | SD-2, 100 | Developer only | B | 17.0 | Comparison |
| CS-2 | SD-1, 75 | Bleach-fix only | A | 49.2 | Comparison |
| CS-2 | SD-1, 75 | Bleach-fix only | B | 18.9 | Comparison |
| CS-2 | SD-2, 100 | Bleach-fix only | A | 39.8 | Comparison |
| CS-2 | SD-2, 100 | Bleach-fix only | B | 20.3 | Comparison |
| CS-2 | SD-1, 75 | Bleach-fix + wash | A | 43.4 | Comparison |
| CS-2 | SD-1, 75 | Bleach-fix + wash | B | 17.6 | Comparison |
| CS-2 | SD-2, 100 | Bleach-fix + wash | A | 32.7 | Comparison |
| CS-2 | SD-2, 100 | Bleach-fix + wash | B | 11.6 | Comparison |
| CS-2 | SD-1, 75 | Wash only | A | 49.9 | Comparison |
| CS-2 | SD-1, 75 | Wash only | B | 20.4 | Comparison |
| CS-2 | SD-2, 100 | Wash only | A | 45.3 | Comparison |
| CS-2 | SD-2, 100 | Wash only | B | 17.0 | Comparison |

The results in Table 5 show that a surfactant introduced during the processing step generally results in lower dye stain (as measured by retained sensitizing dye after processing) compared to coatings where the surfactant is absent from the process solution or solutions. However, the unexpected effect of Table 4, where Processing Method A yielded lower dye stain than Processing Method B in cases with the surfactant present, did not appear. Table 5 shows only the usual expected result that both the surfactant and the PHORWITE REU aid in dye washout, and the combination of both surfactant and PHORWITE REU is best for dye washout in these cases.

TABLE 6
Results of processing bilayer coatings using processing methods A and B.

| | Spectral | Coated Surfactant | Process | Retained Spectral | |
|---|---|---|---|---|---|
| | sensitizing | (11 milligrams per | Method | Sensitizing Dye After | |
| Coating | dye and laydown, | square foot, if | (A = No REU, | Processing (micrograms | |
| Structure | (μg/ft²) | present) | B = REU) | per square foot) | Note |
| CS-3 | SD-1, 75 | None | A | 40.9 | Comparison |
| CS-3 | SD-1, 75 | None | B | 27.6 | Comparison |
| CS-3 | SD-1, 75 | GLUCOPON 600 | A | 17.6 | Invention |
| CS-3 | SD-1, 75 | GLUCOPON 600 | B | 29.8 | Comparison |
| CS-3 | SD-1, 75 | GLUCOPON 625 | A | 10.7 | Invention |
| CS-3 | SD-1, 75 | GLUCOPON 625 | B | 20.6 | Comparison |
| CS-3 | SD-1, 75 | PLURONIC L-44 | A | 14.8 | Invention |
| CS-3 | SD-1, 75 | PLURONIC L-44 | B | 20.1 | Comparison |
| CS-3 | SD-1, 75 | TERGITOL 15-S-15 | A | 19.8 | Invention |
| CS-3 | SD-1, 75 | TERGITOL 15-S-15 | B | 19.6 | Comparison |

The results in Table 6 show that the presence of a surfactant in the imaging element has reduced the dye stain (as measured by retained sensitizing dye after processing) compared to coatings where the surfactant is absent, and also shows the unexpected effect that in most cases the lowest dye stain levels are often achieved when the processing solution does not contain a dye washout agent (such as PHORWITE REU). This is true even though coating structure used for the experiments in Table 6 is different than was used for the experiments in Table 4.

The invention has been described in detail with particular reference to certain preferred embodiments thereof, but it will be understood that variations and modifications can be effected within the spirit and scope of the invention.

1. A method for reducing sensitizing dye stain comprising the steps of:
a. providing an exposed sensitized imaging element comprising a support having thereon at least one imaging layer comprising at least one sensitized emulsion and at least one dye dispersion comprising dye and a dye stain reducing water soluble surfactant comprising a 6 to 22 carbon atom hydrophobic tail with one or more attached hydrophobic chains comprising at least 8 oxyethylene and/or glycidyl units; and
b. processing said exposed sensitized imaging element in a developing solution essentially free of dye washout agent.

2. The method of claim 1 wherein said at least 8 oxyethylene and/or glycidyl units are terminated by an anionic charge.

3. The method of claim 2 wherein said anionic charge is from a sulfate or sulfonate group.

4. The method of claim 1 wherein said exposed sensitized imaging element comprises an exposed color paper.

5. The method of claim 1 wherein said support is a paper support.

6. The method of claim 1 wherein said at least one sensitized emulsion comprises an emulsion sensitized in the blue spectral region.

7. The method of claim 1 wherein said at least one sensitized emulsion comprises an emulsion sensitized in the red spectral region.

8. The method of claim 1 wherein said at least one dye dispersion comprises a cyan dye dispersion.

9. The method of claim 1 wherein said dye stain reducing surfactant comprises at least one ethylene oxide—ethylene glycol copolymer.

10. The method of claim 1 wherein said dye stain reducing surfactant is present in an amount between 2 and 20 mg/ft².

11. The method of claim 9 wherein said dye stain reducing surfactant is present in an amount between 5 and 15 mg/ft².

12. The method of claim 9 wherein said dye stain reducing surfactant is present in an amount between 0.2 and 30 mg/ft².

13. The method of claim 1 wherein the value of B* is reduced by at least 0.5 B* unit.

14. The method of claim 1 wherein the value of Dmin is reduced by at least 2 B* units.

15. The method of claim 1 wherein said dye stain reducing water soluble surfactant is represented by the following structure A-1:

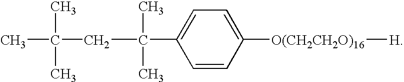

16. The method of claim 1 wherein said dye stain reducing water soluble surfactant is represented by the following structure A-2:
(C₁₁to₁₅-H₂₃ to₃₁)—O—(CH₂CH₂O)₁₅—H

17. The method of claim 1 wherein said dye stain reducing water soluble surfactant is represented by the following structure A-3:
C₁₈H₃₇—O—(CH₂—CH₂—O)₁₀—H

18. The method of claim 1 wherein said dye stain reducing water soluble surfactant is represented by the following structure A-4:

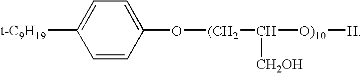

19. The method of claim 1 wherein said dye stain reducing water soluble surfactant is represented by the following structure A-5:
n-C₁₂H₂₅—O—(CH₂—CH₂—O)₂₃—SO₃⁻Na⁺

20. A method for reducing sensitizing dye stain comprising the steps of:
a. providing an exposed sensitized imaging element comprising a support having thereon at least one imaging layer comprising at least one sensitized emulsion and at least one dye dispersion comprising dye and a water soluble polyoxyalkylene polymer dye stain reducing surfactant, wherein said water soluble polyoxyalkylene polymer dye stain reducing surfactant comprises polyoxypropylene blocks (block A) and polyoxyethylene blocks (block B) connected together by an organic moiety whereby there is a minimum of about 40% polyethyleneoxide blocks in the molecule as represented by a structure selected from the group consisting of A-B-A, B-A-B, A-B, (A-B)n==G==(B-A) or (B-A)n==G==(A-B), whereby G is a connective organic moiety and n is between 1 and 3; and
b. processing said exposed sensitized imaging element in a developing solution essentially free of dye washout agent.

21. The method of claim 20 wherein said exposed sensitized imaging element comprises an exposed color paper.

22. The method of claim 20 wherein said support is a paper support.

23. The method of claim 20 wherein said at least one sensitized emulsion comprises an emulsion sensitized in the blue spectral region.

24. The method of claim 20 wherein said at least one sensitized emulsion comprises an emulsion sensitized in the red spectral region.

25. The method of claim 20 wherein said at least one dye dispersion comprises a cyan dye dispersion.

26. The method of claim 20 wherein said a water soluble polyoxyalkylene polymer dye stain reducing surfactant is present in an amount between 1 and 20 mg/ft².

27. The method of claim 20 wherein said a water soluble polyoxyalkylene polymer dye stain reducing surfactant is present in an amount between 5 and 15 mg/ft².

28. The method of claim 20 wherein said a water soluble polyoxyalkylene polymer dye stain reducing surfactant is present in an amount between 8 and 12 mg/ft².

29. The method of claim 20 wherein the value of B* is reduced by at least 0.5 B* unit.

30. The method of claim 20 wherein the value of Dmin is reduced by at least 2 B* units.

31. The method of claim 20 wherein said a water soluble polyoxyalkylene polymer dye stain reducing surfactant is represented by the following structure B-1:

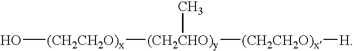

32. The method of claim 20 wherein said a water soluble polyoxyalkylene polymer dye stain reducing surfactant is represented by the following structure B-2:

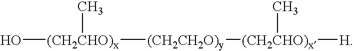

33. The method of claim 20 wherein said a water soluble polyoxyalkylene polymer dye stain reducing surfactant is represented by the following structure B-3:

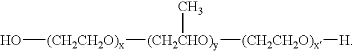

34. The method of claim 20 wherein said a water soluble polyoxyalkylene polymer dye stain reducing surfactant is represented by the following structure B-4:

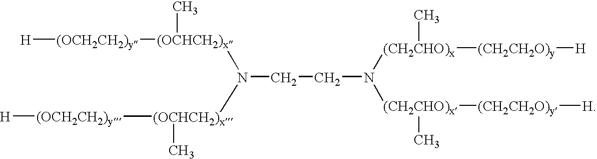

35. A method for reducing sensitizing dye stain comprising the steps of:
a. providing an exposed sensitized imaging element comprising a support having thereon at least one imaging layer comprising at least one sensitized emulsion and at least one dye dispersion comprising dye and a water soluble polyalkylene oxide-modified polydimethylsiloxane dye stain reducing surfactant of the general formula given by C: 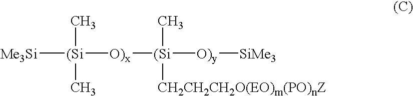
wherein, EO represents ethylene oxide, PO represents propylene oxide, and Z can be either H or a lower alkyl radical; and
b. processing said exposed sensitized imaging element in a developing solution essentially free of dye washout agent.

36. The method of claim 35 wherein said exposed sensitized imaging element comprises an exposed color paper.

37. The method of claim 35 wherein said support is a paper support.

38. The method of claim 35 wherein said at least one sensitized emulsion comprises an emulsion sensitized in the blue spectral region.

39. The method of claim 35 wherein said at least one sensitized emulsion comprises an emulsion sensitized in the red spectral region.

40. The method of claim 35 wherein said at least one dye dispersion comprises a cyan dye dispersion.

41. The method of claim 35 wherein said polyalkylene oxide-modified polydimethylsiloxane dye stain reducing surfactant is present in an amount between 1 and 20 mg/ft².

42. The method of claim 35 wherein said polyalkylene oxide-modified polydimethylsiloxane dye stain reducing surfactant is present in an amount between 5 and 15 mg/ft².

43. The method of claim 35 wherein said polyalkylene oxide-modified polydimethylsiloxane dye stain reducing surfactant is present in an amount between 8 and 12 mg/ft².

44. The method of claim 35 wherein the value of B* is reduced by at least 0.5 B* unit.

45. The method of claim 35 wherein the value of Dmin is reduced by at least 2 B* units.

46. The method of claim 35 wherein said water soluble polyalkylene oxide-modified polydimethylsiloxanes dye stain reducing surfactant wherein Z is hydrogen and n is 0.

47. The method of claim 35 wherein said water soluble polyalkylene oxide-modified polydimethylsiloxanes dye stain reducing surfactant wherein the ratio of m:n is 60:40.

48. The method of claim 35 wherein said water soluble polyalkylene oxide-modified polydimethylsiloxanes dye stain reducing surfactant wherein Z is hydrogen, and the ratio of m:n is 75:25.

49. The method of claim 35 wherein said water soluble polyalkylene oxide-modified polydimethylsiloxanes dye stain reducing surfactant wherein Z is CH₃ and n is 0.

50. A method for reducing sensitizing dye stain comprising the steps of providing an exposed sensitized imaging element comprising a support having thereon at least one imaging layer comprising at least one sensitized emulsion and at least one dye dispersion comprising dye and a water soluble alkylpolyglycoside dye stain reducing surfactant of general formula D: 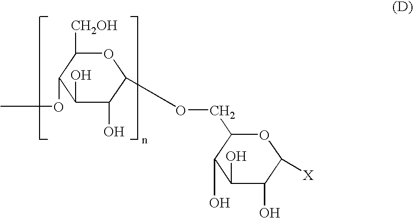
wherein, n is 0 to 3 carbohydrate units, and X represents a group of type R₁, OR₁, SR₁, or N(R₁)(R₂), wherein R₁ represents functional groups selected from the goup consisting of carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide; and R₂ is selected from the group consisting of a hydrogen atom, carboxamide, ketone, sulfone, sulfoxide, sulfonamide, urea, phosphonate, phosphate ester, carboxylic ester, or a branched and unbranched alkyl, aryl, alkenyl, arylalkyl, carbocyclic, or heterocyclic group, optionally bearing additional substituents including carboxamide, ketone, sulfone, sulfoxide, sulfonamide, urea, carboxylic ester, alcohol, amine, or sulfide; and
b. processing said exposed sensitized imaging element in a developing solution essentially free of dye washout agent.

51. The method of claim 50 wherein X represents a group OR,.

52. The method of claim 51 wherein R₁ is a linear alkyl chain with an average length comprising from 8 or more carbons.

53. The method of claim 51 wherein R₁ is a linear alkyl chain with an average length comprising 10 or more carbons and most preferably 12 or more carbons.

54. The method of claim 51 wherein R₁ is a linear alkyl chain with an average length comprising 12 or more carbons.

55. The method of claim 51 wherein the number of carbons in R₁ is from 8 to 16 and the average number of carbohydrate units, n, is 1.5.

56. The method of claim 51 wherein the number of carbons in R₁ is from 12 to 16 and the average number of carbohydrate units, n, is 1.4.

57. The method of claim 51 wherein the number of carbons in R₁ is from 12 to 16 and the average number of carbohydrate units, n, is 1.6.

58. The method of claim 50 wherein said exposed sensitized imaging element comprises an exposed color paper.

59. The method of claim 50 wherein said support is a paper support.

60. The method of claim 50 wherein said at least one sensitized emulsion comprises an emulsion sensitized in the blue spectral region.

61. The method of claim 50 wherein said at least one sensitized emulsion comprises an emulsion sensitized in the red spectral region.

62. The method of claim 50 wherein said at least one dye dispersion comprises a cyan dye dispersion.

63. The method of claim 50 wherein said alkylpolyglycoside dye stain reducing surfactant is present in an amount between 1 and 20 mg/ft².

64. The method of claim 50 wherein said alkylpolyglycoside dye stain reducing surfactant is present in an amount between 5 and 15 mg/ft².

65. The method of claim 50 wherein said alkylpolyglycoside dye stain reducing surfactant is present in an amount between 8 and 12 mg/ft².

66. The method of claim 50 wherein the value of B* is reduced by at least 0.5 B* unit.

67. The method of claim 50 wherein the value of Dmin is reduced by at least 2 B* units.
